(19) United States
(12) Patent Application Publication
(10) Pub. No.: US 2008/0158784 A1
(43) Pub. Date: Jul. 3, 2008

(54) Electrode for electrolytic capacitor

(75) Inventors: Jenn-Yeu Hwang, Hsinchu (TW); Li-Duan Tsai, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/889,154

(22) Filed: Aug. 9, 2007

(30) Foreign Application Priority Data
Dec. 28, 2006 (TW) 095149398

(51) Int. Cl. H01G 9/045

(52) U.S. Cl. 361/529

(57) ABSTRACT

An electrode for an electrolytic capacitor is disclosed, including a substrate and a metal oxide formed on the surface of the substrate, wherein the metal oxide is formed on the surface of the substrate by a chemical reaction between a precursor and functional groups on the surface of the substrate. The surface of the substrate is covered with a metal oxide for increasing the capacitance of the electrode. The metal oxide-covered substrate is suitable for being used as an electrode of an electrolytic capacitor in that the metal oxide formed on the surface of the substrate by chemical linking is of excellent peeling resistance.

### FIELD OF THE INVENTION

The present invention relates to electrodes for an electrolytic capacitor. In particular, the present invention is directed to an electrode for an electrolytic capacitor covered with a metal oxide.

### BACKGROUND OF THE INVENTION

Aluminum foils are generally employed as the anode and the cathode in the structure of an aluminum electrolytic capacitor, wherein the anode aluminum foil is etched to form a porous structure so as to increase the surface area thereof, and hence the charge capacity. The porous electrode is then subjected to an electrochemical formation process to form an aluminum oxide layer for use as a dielectric layer.

The capacitance of a capacitor is calculated according to the following equation: C=ε(A/d), wherein C is capacitance, ε is the dielectric constant, A is the surface area of the electrode, and d is the thickness of the dielectric layer. The surface area is defined by not only the overall dimensions but also the porousness of the material. Thus, the process used to form the dielectric oxide layer of the electrode of an electrolytic capacitor, particularly the anode, is critical in determining the capacitance.

Generally, the dielectric layer of an aluminum foil anode for use in an aluminum electrolytic capacitor is composed of aluminum oxide. The dielectric constant of such aluminum oxide is typically from about 8 to 12. Increasing the capacitance of a capacitor can be achieved by: decreasing the thickness of the dielectric layer (d), increasing the electrode surface area (A), and/or altering the dielectric constant (ε). However, the aluminum foil anode typically employed offers little potential to significantly enhance the capacitance by electroetching technology because further etching may fracture the aluminum material due to the insufficient strength. From another aspect, increasing the capacitance by reducing the thickness of the dielectric layer would require altering the conditions of formation, possibly causing the dielectric layer to be unstable in terms of fabrication or repeatability. Thus, it is difficult to increase the capacitance by electroetching or to drcrease the thickness of the dielectric layer controlling the formation conditions.

However, due to the directly proportional relationship between the capacitance of an electrolytic capacitor and the dielectric constants, an increase of capacitance of the anode can be achieved by employing a material having a higher dielectric constant. For example, a valve metal oxide comprising Ti, Nb, Zr, Hf, or Ta may be introduced into the structure of the aluminum oxide anode, such as Ta₂O₅ (ε, 26-27), Nb₂O₅ (ε, 41-42), TiO₂ (ε, 40-100), and even the derivative of Ti—Ba oxide (ε, hundreds to thousands).

A method for growing Nb and the oxide thereof by evaporation is provided in JP 05-009710. However, it is unfavorable from a cost standpoint because of the expensive apparatus for cathodic-arc plasma deposition. A method of adding a variety of metal oxides, nitride, or carbide during aluminum casting is provided in Japan Patent Publication Number 2000-012402, but such method is effected via a multifarious procedure of dissolving casting at high temperature, wherein it is also hard to uniformly disperse particles into the substrate. A method disclosed in Japan Patent Publication Number 2000-012400 is to coat the mixture of a binder and a variety of valve metal-containing oxides, nitride, or carbide particles on the aluminum foil. However, these particles mechanically bind with the substrate and also with other said particles, and thus may pose a risk of peeling between the particles and the substrate or between the particles.

In view of the above drawbacks a need exists to produce an electrode for an electrolytic capacitor having both high capacitance and a simple manufacturing process. In addition, there exists a need for a electrolytic capacitor electrode in which the covering on the surface does not peel off easily.

### SUMMARY OF THE INVENTION

To solve the above problems, a primary objective of the present invention is to provide an electrode for an electrolytic capacitor having high capacitance.

Another objective of the invention is to provide an electrode for an electrolytic capacitor that has a covering on the surface that does not peel off easily.

A further objective of the invention is to provide an electrode of electrolytic capacitor having high capacitance that has a simple manufacturing process.

To achieve the above objectives, the present invention provides an electrode for an electrolytic capacitor comprising: a substrate and a metal oxide formed on the surface of the substrate, wherein the metal oxide is formed on the surface of the substrate by a chemical reaction between a precursor and functional groups on the surface of the substrate. The surface of the electrode substrate is covered with a metal oxide for increasing the capacitance of the electrode. The metal oxide-covered substrate is suitable for being used as an electrode of an electrolytic capacitor in that the metal oxide formed on the surface of the substrate by chemical linking does not peel off easily.

### DETAILED DESCRIPTION OF THE EMBODIMENTS

The electrode of the electrolytic capacitor of the invention comprises a substrate and a metal oxide formed on the surface of the substrate by chemical linking. In one embodiment, the material of the substrate is a porous etched or formed aluminum foil. Since the aluminum foil has plenty of hydroxyl functional groups that are present in the form of aluminum hydroxide on the surface, the structural formula Al—O-M (M is metal) can be formed following contact between the aluminum foil and a precursor reactive to the hydroxyl groups. Further, the aluminum foil can be processed to have Al— and M-containing oxides by a heat treatment, wherein metal oxides are formed on the surface of the substrate.

The contact between the aluminum foil and a precursor can be performed in any manner. In one embodiment of the invention, the precursor was formulated in a solution, and then the substrate was sufficiently contacted with the precursor by injection, spraying, impregnation, or vapor-phase contact. As described above, the structural formula Al—O-M was formed on the surface of the aluminum foil. To form the metal oxides on the substrate surface of the electrode of the electrolytic capacitor of the invention, a heat treatment is generally carried out in a temperature range from 30° C. to 600° C., and preferably 100° C. to 500° C.

The hydroxyl-reactive precursors for contact with the aluminum foil of the invention satisfy Formula (I):

M(OR)n (I)

### Wherein:

M is a metal selected from the group comprising Al, Ba, Ti, V, Zr, Hf, Nb, Ta, Mo, W, Si, and Sn;

R is —CH₃—, —C₂H₅—, -(n-C₃H₇)—, -(i-C₃H₇), -(n-C₄H₉), -(i-C₄H₉), or —C(CH₃)₃; and

n is an integer from 1 to 6.

The metal alkoxides can directly react with the —OH group on the surface of the aluminum foil, or the alkoxides can be converted to M(OH)n by hydrolysis prior to the reaction. The metal alkoxides are preferably valve metal alkoxides having a dielectric property, such as the metal alkoxides of Ti, Nb, Zr, Hf, Ta and Al, and preferably the metal alkoxides of Ti or Nb, which are particularly suitable for modifying the aluminum foil of the electrode of an electrolytic capacitor.

Covering a metal oxide layer having a high dielectric constant on the surface of the aluminum foil substrate can effectively increase the capacitance of the electrode. Such a metal oxide has a higher dielectric constant than aluminum oxide. Such metal oxides comprise, for example, but are not limited to, the oxides of titanium (Ti), niobium (Nb), zirconium (Zr), hafnium (Hf), tantalun (Ta), aluminum (Al), titanium-Barium (Ti—Ba) oxide derivative, or compositions thereof. For the electrode of the invention, the metal oxide is formed on the surface of the substrate by chemical linking between the metal alkoxides precursor and the aluminum foil on the surface of the substrate. In such a simple way, an electrode for an electrolytic capacitor is obtained that has a high capacitance.

The present invention will be described below through specific examples. However, the present invention is not limited to the forms shown in the examples.

### EXAMPLES

### Comparative Example 1

A thermal treatment was performned for a porous aluminum foil (1 cm×5 cm, KDK U157) used as the electrode substrate in air for 30 minutes. The capacitance of the electrode foil after the heat treatment process was then measured at 120 Hz in an aqueous solution of ammonium adipate (15% wt). The result is disclosed in Table 1.

### Example 1

A solution of Nb(OC₂H₅)₅ was prepared in ethanol(Nb(OC₂H₅)₅: ethanol=1:19) as the precursor solution. A porous aluminum foil (1 cm×5 cm, KDK U157) is used as the electrode substrate. The electrode substrate was then introduced to the precursor solution, so as to bring them into contact with each other. Following the reaction between the substrate and the precursor solution, a heat treatment was then performed in air for 30 minutes to form an Nb oxide on the surface of the aluminum foil. The capacitance of the electrode foil obtained was then measured at 120 Hz in an aqueous solution of ammonium adipate (15% wt). The result is disclosed in Table 1.

### Example 2

A solution of Ti(i-OC₃H₇)₄ was prepared in isopropanol (Ti(i-OC₃H₇)₄: isopropanol=1:19) as a precursor solution. A porous aluminum foil (1 cm×5 cm, KDK U157) was used as the electrode substrate. The electrode substrate was then introduced to the precursor solution, so as to bring them into contact with each other. Following the reaction betveen the substrate and the precursor solution, a heat treatment was then performed in air for 30 minutes to form a Ti oxide on the surface of the aluminum foil. The capacitance of the electrode foil obtained was then measured at 120 Hz in an aqueous solution of ammonium adipate (15% wt). The result is disclosed in Table 1.

TABLE 1

| Ex. Nos. | Precursor | Capacitance(μF) |
|---|---|---|
| Comparative 1 | — | 1260 |
| Example 1 | Nb(OC₂H₅)₅ | 1295 |
| Example 2 | Ti(i-OC₃H₇)₄ | 1315 |

As the results shown above, the modified electrodes (comprising aluminum foil on which the metal oxide layer was formed by heat treatment following reaction with the precursor) resulted in an increase in capacitance from 2.8 to 4.4% compared to that without treatment.

### Comparative Example 2

A porous aluminum foil (1 cm×5 cm, KDK U157) was used as the electrode substrate and subjected to a heat treatment process in air for 30 minutes, and then the heat treatment process was repeated. The capacitance of the electrode foil after heat treatment was then measured at 120 Hz in an aqueous solution of ammonium adipate (15% wt), wherein such capacitance C₀ is defined as the 100% standard. The result is disclosed in Table 2.

### Example 3

A solution of Nb(OC₂H₅)₅ was prepared in ethanol as the precursor solution. A porous aluminum foil (1 cm×5 cm, KDK U157) was used as the electrode substrate. The electrode substrate is then introduced to the precursor solution, so as to bring them into contact with each other. Following the reaction between the substrate and the precursor solution, a heat treatment was then performed in air for 30 minutes, and then the reaction and the heat treatment processes above were repeated to form an Nb oxide on the surface of the aluminum foil. The capacitance of the electrode foil obtained was then measured at 120 Hz in an aqueous solution of ammonium adipate (15% wt) and compared to the standard capacitance C₀. The result is disclosed in Table 2.

### Example 4

A solution of Ti(i-OC₃H₇)₄ was prepared in isopropanol as the precursor solution. A porous aluminum foil (1 cm×5 cm, KDK U157) was used as the electrode substrate. The electrode substrate was then introduced to the precursor solution, so as to bring them into contact with each other. Following the reaction between the substrate and the precursor solution, a heat treatment was then performed in air for 30 minutes, and then the reaction and the heat treatment processes above were repeated to form a Ti oxide on the surface of the aluminum foil. The capacitance of the electrode foil obtained was then measured at 120 Hz in an aqueous solution of ammonium adipate (15% wt) and compared to the standard capacitanceco. The result is disclosed in Table 2.

TABLE 2

| Ex. Nos. | Precursor | Capacitance C/C₀ (%) |
|---|---|---|
| Comparative 2 | — | 100.0 |
| Example 3 | Nb(OC₂H₅)₅ | 100.8 |
| Example 4 | Ti(i-OC₃H₇)₄ | 109.8 |

As shown in Table 2, the modified electrodes (comprising aluminum foil on which the Ti oxide layer was formed from repeating the reaction and the heat treatment processes) resulted in an increase in the capacitance compared to electrodes made of aluminum foil without a metal oxide-covering.

### Example 5

The process of example 4 was repeated, while the concentration of the precursor solution was increased 2-fold compared to that in example 4. The result is disclosed in Table 3.

### Example 6

The process of example 4 was repeated, while the concentration of the precursor solution was increased 3-fold compared to that in example 4. The result is disclosed in Table 3.

### Example 7

The process of example 4 was repeated, while the concentration of the precursor solution was increased 5-fold compared to that in example 4. The result is disclosed in Table 3.

TABLE 3
The concentrations of the Ti-containing precursor solutions
versus the capacitance of the electrode foil

| Ex. Nos. | Capacitance C/C₀ (%) |
|---|---|
| Comparative 2 | 100.0 |
| Example 5 | 113.1 |
| Example 6 | 115.1 |
| Example 7 | 116.7 |

As shown above, a higher capacitance resulted from increasing the concentration of the precursor solution.

The foregoing examples are offered by way of illustration of the invention and not by way of limitation. Other versions are possible, and alterations, permutations and equivalents of the version shown will be apparent to those skilled in the art upon a reading of the specification and study of the drawings. Thus, the scope thereof is determined by the claims that follow.

What is claimed is:

1. An electrode of an electrolytic capacitor, comprising:
a substrate; and
a metal oxide formed on a surface of the substrate by chemical linking through a chemical reaction between a precursor and functional groups on the surface of the substrate.

2. The electrode of an electrolytic capacitor according to claim 1, wherein the substrate is an aluminum substrate.

3. The electrode of an electrolytic capacitor according to claim 2, wherein the aluminum substrate is a porous aluminum foil.

4. The electrode of an electrolytic capacitor according to claim 1, wherein the metal oxide has a higher dielectric constant compared with aluminum oxide.

5. The electrode of an electrolytic capacitor according to claim 1, wherein the metal oxide is selected from the group consisting of the oxides of titanium (Ti), niobium (Nb), zirconium (Zr), hafnium (Hf), tantalum (Ta), aluminum (Al) and titanium-Barium (Ti—Ba) oxide derivative.

6. The electrode of an electrolytic capacitor according to claim 1, wherein the metal oxide is subjected to a heat treatment at high temperature following the chemical reaction between the precursor and the functional groups on the surface of the substrate.

7. The electrode of an electrolytic capacitor according to claim 6, wherein the precursor is selected from the group consisting of the metal alkoxides of Ti, Nb, Zr, Hf, Ta and Al.

8. The electrode of an electrolytic capacitor according to claim 6, wherein the functional group is hydroxyl group.
